(19) United States
(12) Patent Application Publication
(10) Pub. No.: US 2012/0123044 A1
(43) Pub. Date: May 17, 2012

(54) POLYAMIDES THAT RESIST HEAT-AGING

(75) Inventors: Manoranjan Prusty, Mannheim (DE); Martin Baumert, Dossenheim (DE); Hans-Joachim Hähnle, Neustadt (DE)

(73) Assignee: BASF SE, Ludwigshafen (DE)

(21) Appl. No.: 13/285,060

(22) Filed: Oct. 31, 2011

Related U.S. Application Data
(60) Provisional application No. 61/412,409, filed on Nov. 11, 2010.

(51) Int. Cl. C08L 77/06; C08K 7/02; C08L 33/24; C08L 33/26; C08L 77/02

(52) U.S. Cl. 524/514; 525/183

(57) ABSTRACT

Thermoplastic molding compositions comprising
A) from 10 to 99% by weight of a polyamide,
B) from 0.1 to 20% by weight of
   B1) a polyacrylamide or
   B2) a polyvinylamide, or a mixture of these,
C) from 0 to 70% by weight of further additives,
   where the total of the percentages by weight of components A) to C) is 100%.

The invention relates to thermoplastic molding compositions comprising
A) from 10 to 99% by weight of a polyamide
B) from 0.1 to 20% by weight of
   B1) a polyacrylamide or
   B2) a polyvinylamide, or a mixture of these
C) from 0 to 70% by weight of further additives, where the total of the percentages by weight of components A) to C) is 100%.

The invention further relates to the use of the molding compositions of the invention for producing fibers, foils and moldings of any type, and also to the moldings thus obtainable.

Thermoplastic polyamides, such as PA6 and PA66, are often used in the form of glass fiber-reinforced molding compositions as materials in the design of components which during their lifetime have exposure to elevated temperatures, with thermooxidative degradation. Although the thermooxidative degradation can be delayed by adding known heat stabilizers, it cannot be prevented in the long term, and becomes apparent by way of example in a reduced level of mechanical properties. It is highly desirable to improve the heat-aging resistance (HAR) of polyamides, since this can achieve longer lifetimes for components subject to thermal stress, or can reduce the risk that these fail. As an alternative, improved HAR can also permit the use of the components at higher temperatures.

The use of elemental iron powder in polyamides is known from DE-A 26 02 449, JP-A-09/221,590, JP-A 2000/86889 (in each case as filler), JP-A 2000/256 123 (as decorative addition), and also WO 2006/074912, and WO 2005/007727 (stabilizers).

EP-A 1 846 506 discloses a combination of Cu-containing stabilizers with iron oxides for polyamides.

Organic stabilizers, such as HALS, or sterically hindered phenols, can be found by way of example in Gächter/Müller Kunststoffadditive [Plastics Additives], 3rd edition, Carl Hanser Verlag, Munich, Vienna, 1989, pp. 42-50.

The known molding compositions still have inadequate heat-aging resistance, in particular over prolonged periods of thermal stress.

It was therefore an object of the present invention to provide thermoplastic polyamide molding compositions which have improved HAR and a good surface after heat-aging, and also good mechanical properties.

Accordingly, the molding compositions defined in the introduction were discovered. Preferred embodiments can be found in the dependent claims.

The molding compositions of the invention comprise, as component A), from 10 to 99% by weight, preferably from 20 to 98% by weight, and in particular from 25 to 90% by weight, of at least one polyamide.

The polyamides of the molding compositions of the invention generally have an intrinsic viscosity of from 90 to 350 ml/g, preferably from 110 to 240 ml/g, determined in a 0.5% strength by weight solution in 96% strength by weight sulfuric acid at 25° C. to ISO 307.

Preference is given to semicrystalline or amorphous resins with a molecular weight (weight average) of at least 5000, described by way of example in the following U.S. Pat. Nos. 2,071,250, 2,071,251, 2,130,523, 2,130,948, 2,241,322, 2,312,966, 2,512,606, and 3,393,210.

Examples of these are polyamides that derive from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Merely as examples, those that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine (e.g. Ultramid® X17 from BASF SE, where the molar ratio of MXDA to adipic acid is 1:1), di(4-aminophenyl)methane, di(4-aminocyclohexyl)methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from w-aminoalkylnitriles, e.g. aminocapronitrile (PA 6) and adipodinitrile with hexamethylenediamine (PA 66) via what is known as direct polymerization in the presence of water, for example as described in DE-A 10313681, EP-A-1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6/6T and PA 66/6T, where the triamine content of these is less than 0.5% by weight, preferably less than 0.3% by weight (see EP-A 299 444). Other polyamides resistant to high temperatures are known from EP-A 19 94 075 (PA 6T/6T/MXD6).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers comprised:

### AB Polymers:

### PA 4 Pyrrolidone

### PA 6 ε-Caprolactam

### PA 7 Ethanolactam

### PA 8 Caprylolactam

PA 9 9-Aminopelargonic acid
PA 11 11-Aminoundecanoic acid

### PA 12 Laurolactam

### AA/BB Polymers

PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 9T 1,9-Nonanediamine, adipic acid
PA 61 Hexamethylenediamine, isophthalic acid
PA 6-3-T Trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 6I/6T (see PA 61 and PA 6T)

PA PACM 12 Diaminodicyclohexylmethane, laurolactam
PA 61/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

The molding compositions of the invention comprise, as component B), from 0.1 to 20% by weight, preferably from 0.1 to 10% by weight, in particular from 0.1 to 5% by weight, of

B1) a polyacrylamide or
B2) a polyvinylamide or

a mixture of these.

Component B1) of the invention is obtainable via free-radical polymerization of monomers of the formula I

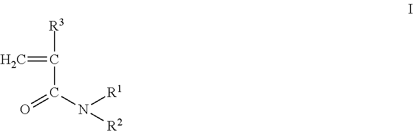

in which R¹ and R², independently of one another, are hydrogen or C₁-C₆-alkyl, preferably hydrogen, and R¹ and R² is hydrogen, and R³ is hydrogen or methyl.

The K value of preferred components B1) (1% strength in water at 25° C. and pH 7 (as in H. Fikentscher, Cellulosechemie, volume 13, 48 to 64 and 71 to 74, 1932)) is from 10 to 200, preferably from 20 to 100.

The solids content of the aqueous solutions after the polymerization reaction is generally from 1 to 60%, preferably from 5 to 40% (determined gravimetrically after drying in a convection oven for 2 hours at 140° C.).

The average molecular weights M_{w} of preferred components B1) are from 5000 to 5 000 000, in particular from 15 000 to 500 000 (static light scattering in 10 mmolar aqueous sodium chloride solution at pH 7.6). Suitable processes for producing component B1) are known to the person skilled in the art, and there is therefore no need for further details.

Component B2) is polyvinylamides, where these are obtainable via free-radical polymerization of monomers of the formula II

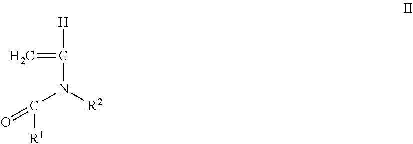

in which R¹ and R², independently of one another, are hydrogen or C₁-C₆-alkyl, preferably hydrogen, methyl, or ethyl.

The K value of preferred components B2) (1% strength in water at 25° C. and pH 7 (as in H. Fikentscher, Cellulosechemie, volume 13, 48 to 69 and 71 to 74, 1932)) is from 15 to 250, preferably from 40 to 150.

The solids content of the aqueous solutions after the polymerization reaction is generally from 1 to 60%, preferably from 10 to 40% (determined gravimetrically after drying in a convection oven for 2 hours at 140° C.).

The average molecular weights M_{w} (weight average) of preferred components B2 are from 15 000 to 10 000 000, in particular from 40 000 to 800 000 (static light scattering in 10 mmolar aqueous sodium chloride solution at pH 7.6).

Processes for producing component B2) or copolymers of B2) with other monomers can be found by way of example in EP-A 71050.

Examples of monomers of the formula II are N-vinylformamide, N-vinyl-N-methylformamide, N-vinylacetamide, N-vinyl-N-methylacetamide, N-vinyl-N-ethylacetamide, N-vinylpropionamide, and N-vinyl-N-methylpropionamide and N-vinylbutyramide. Said monomers can be polymerized alone or in the form of mixtures. Preferred monomer used from this group is N-vinylformamide.

These polymers can optionally have been modified by copolymerizing the N-vinylcarboxamides (i) together with (ii) at least one other monoethylenically unsaturated monomer.

The compositions can comprise from 20 to 100 mol % of the vinylcarboxamides and from 80 to 0% of the monomers of type II. Preference is given to polymers having >50 mol % of vinylamide units, and particular preference is given to those having >70 mol % content.

Examples of monomers of the group (ii) are esters of α,β-ethylenically unsaturated mono- and dicarboxylic acids with C₁-C₃₀-alkanols, with C₂-C₃₀-alkanediols, and with C₂-C₃₀-amino alcohols, amides of α,β-ethylenically unsaturated monocarboxylic acids, and the N-alkyl and N,N-dialkyl derivatives thereof, nitriles of α,β-ethylenically unsaturated mono- and dicarboxylic acids, esters of vinyl alcohol and allyl alcohol with C₁-C₃₀-monocarboxylic acids, N-vinyllactams, nitrogen-containing heterocycles having α,β-ethylenically unsaturated double bonds, vinylaromatics, vinyl halides, vinylidene halides, C₂-C₈-monoolefins, and mixtures thereof.

Examples of suitable representative compounds are methyl (meth)acrylate (where this expression here and also hereinafter means not only “acrylates” but also “methacrylates”), methyl ethacrylate, ethyl (meth)acrylate, ethyl ethacrylate, n-butyl (meth)acrylate, isobutyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate, and mixtures thereof.

Other suitable additional monomers of the group (ii) are the esters of α,β-ethylenically unsaturated mono- and dicarboxylic acids with amino alcohols, preferably with C₂-C₁₂-amino alcohols. These can have C₁-C₈-mono- or dialkylation at the amine nitrogen. Examples of a suitable acid component of said esters are acrylic acid, methacrylic acid, fumaric acid, maleic acid, itaconic acid, crotonic acid, maleic anhydride, monobutyl maleate, and mixtures thereof. It is preferable to use acrylic acid, methacrylic acid, or a mixture thereof. Examples of these compounds are N-methylaminomethyl (meth)acrylate, N-methylaminoethyl (meth)acrylate, N,N-dimethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, and N,N-dimethylaminocyclohexyl (meth)acrylate.

Other suitable monomers of the group (ii) are 2-hydroxyethyl (meth)acrylate, 2-hydroxyethyl ethacrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate, and mixtures thereof.

Other suitable additional monomers of the group (ii) are acrylamide, methacrylamide, N-methyl(meth)acrylamide, N-ethyl(meth)acrylamide, n-propyl(meth)acrylamide, N-(n-butyl)(meth)acrylamide, tert-butyl(meth)acrylamide, n-octyl(meth)acrylamide, 1,1,3,3-tetramethylbutyl(meth)acrylamide, ethylhexyl(meth)acrylamide, and mixtures thereof.

Other suitable further monomers of the group (ii) are N[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[2-(diethylamino)ethyl]methacrylamide, and mixtures thereof.

Other examples of monomers of the group (ii) are nitriles of α,β-ethylenically unsaturated mono- and dicarboxylic acids, for example acrylonitrile and methacrylonitrile. Other suitable monomers of the group (ii) are N-vinyllactams and derivatives of these, where these by way of example can have one or more C₁-C₆-alkyl substituents (as defined above). Among these are N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, and mixtures of these.

Other suitable monomers of the group (ii) are N-vinylimidazoles and alkylvinylimidazoles, in particular methylvinylimidazoles, such as 1-vinyl-2-methylimidazole, 3-vinylimidazole N-oxide, 2- and 4-vinylpyridine N-oxides, and also betainic derivatives and quaternization products of said monomers, and also ethylene, propylene, isobutylene, butadiene, styrene, α-methylstyrene, vinyl acetate, vinyl propionate, vinyl chloride, vinylidene chloride, vinyl fluoride, vinylidene fluoride, and mixtures thereof.

Monomers of the group (ii) can also be of anionic type. Examples are ethylenically unsaturated C₃-C₈-carboxylic acids, such as acrylic acid, methacrylic acid, dimethacrylic acid, ethacrylic acid, maleic acid, fumaric acid, itaconic acid, mesaconic acid, citraconic acid, methylenemalonic acid, allylacetic acid, vinylacetic acid, and crotonic acid. Other suitable monomers of said group are monomers comprising sulfo groups, for example vinylsulfonic acid, acrylamido-2-methylpropanesulfonic acid, and styrenesulfonic acid, and also monomers comprising phosphonic groups, e.g. vinylphosphonic acid. The anionic monomers can be in partially or completely neutralized form when they are used in the copolymerization reaction. Examples of compounds used for neutralization are alkali metal bases or alkaline earth metal bases, ammonia, amines, and/or alkanolamines. Examples of these are sodium hydroxide solution, potassium hydroxide solution, soda, potash, sodium hydrogen carbonate, magnesium oxide, calcium hydroxide, calcium oxide, triethanolamine, ethanolamine, morpholine, diethylenetriamine, and tetraethylenepentamine.

Another type of modification of the copolymers can be achieved by using, during the copolymerization reaction, monomers of the group (iii), where these comprise at least two double bonds within the molecule, examples being triallylamine, methylenebisacrylamide, glycol diacrylate, glycol dimethacrylate, glycerol triacrylate, pentaerythritol triallyl ether, at least doubly acrylic-acid- and/or methacrylic-acid-esterified polyalkylene glycols, or polyols, e.g. pentaerythritol, sorbitol, or glucose. If at least one monomer of the above group is used in the polymerization reaction, the amounts used are up to 2 mol %, e.g. from 0.001 to 1 mol %.

For modification of the polymers it can moreover be useful to combine the use of above crosslinking agents with the addition of regulators. The amounts typically used are from 0.001 to 5 mol %. Any of the regulators known from the literature can be used, examples being sulfur compounds, such as mercaptoethanol, 2-ethylhexyl thioglycolate, thioglycolic acid, and dodecyl mercaptan, and also sodium hypophosphite, formic acid, or tribromochloromethane.

Among the polyvinylamides are also graft polymers of, for example, N-vinylformamide on polyalkylene glycols, on polyvinyl acetate, on polyvinyl alcohol, on polyvinylformamides, on polysaccharides, such as starch, or on oligosaccharides or on monosaccharides. The graft polymers can be obtained by, for example, free-radical polymerization of N-vinylformamide in an aqueous medium in the presence of at least one of the abovementioned graft bases, optionally together with other copolymerizable monomers.

The K values of these polymers are by way of example in the range from 20 to 250, preferably from 50 to 150 (determined by the method of H. Fikentscher in 5% strength aqueous sodium chloride solution at pH 7, at a polymer concentration of 0.5% by weight and at a temperature of 25° C.).

The polyvinylamides described above can be produced via free-radical homo- or copolymerization in the form of solution, precipitation, suspension, gel, or emulsion polymerization. Preference is given to solution polymerization in aqueous media, or gel polymerization.

The polymerization temperatures are preferably in the range of about 30 to 200° C., particularly preferably 40 to 110° C. The polymerization reaction usually takes place at atmospheric pressure, but it can also proceed under reduced or increased pressure. A suitable range of pressure is from 0.1 to 5 bar.

Production of the polymers can be achieved by polymerizing the monomers with the aid of initiators that form free radicals.

Initiators that can be used for the free-radical polymerization reaction are the peroxo and/or azo compounds that are conventional for this purpose, examples being alkaline metal peroxydisulfates or ammonium peroxydisulfates, diacetyl peroxide, dibenzoyl peroxide, succinyl peroxide, di-tert-butyl peroxide, tert-butyl perbenzoate, tert-butyl perpivalate, tert-butyl 2-ethylperoxyhexanoate, tert-butyl permaleate, cumene hydroperoxide, diisopropyl peroxydicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, azobis(2-amidinopropane) dihydrochloride, or 2,2′-azobis(2-methylbutyronitrile). Initiator mixtures or redox initiator systems are also suitable, examples being ascorbic acid/iron(II) sulfate/sodium peroxodisulfate, tert-butyl hydroperoxide/sodium disulfite, tert-butyl hydroperoxide/sodium hydroxymethanesulfinate, H₂O₂/CuI.

The molding compositions of the invention can comprise, as component C), up to 70% by weight, preferably up to 50% by weight, of further additives.

Fibrous or particulate fillers C1) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, the amounts used of these being from 1 to 50% by weight, in particular from 1 to 40% by weight, preferably from 10 to 40% by weight.

### Preferred Compositions Comprise

A) from 20 to 98% by weight
B) from 0.1 to 10% by weight
C1) from 1 to 40% by weight of a fibrous or particulate filler, or a mixture of these
C2) from 0 to 50% by weight of further additives C2), different from C1).

Preferred fibrous fillers that may be mentioned are carbon fibers, aramid fibers, and potassium titanate fibers, and particular preference is given here to glass fibers in the form of E glass. These can be used in the form of rovings or of chopped glass, in the forms commercially available.

The fibrous fillers can have been surface-pretreated with a silane compound in order to improve compatibility with the thermoplastic.

Suitable silane compounds are those of the general formula

(X—(CH₂)ₙ)ₖ—Si—(O—CₘH₂ₘ₊₁)₄₋ₖ

in which the meanings of the substituents are as follows:

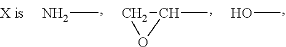

n is an integer from 2 to 10, preferably from 3 to 4
m is an integer from 1 to 5, preferably from 1 to 2
k is an integer from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on E)).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, optionally, have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The molding compositions of the invention can comprise, as component C2), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate, and a mixture made of Al distearate with Al tristearate (Alugel® 30DF from Baerlocher).

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component C2), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols C2) are in principle all of the compounds which have a phenolic structure and which have at least one bulky group on the phenolic ring.

It is preferable to use, for example, compounds of the formula

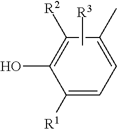

where:

R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, in particular from substituted benzenepropionic acids.

Particularly preferred compounds from this class are compounds of the formula

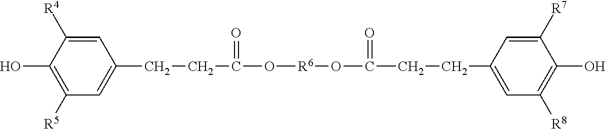

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

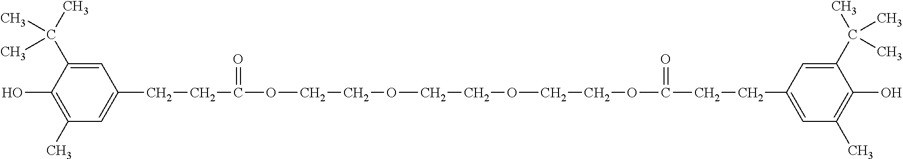

(Irganox® 245 from Ciba-Geigy)

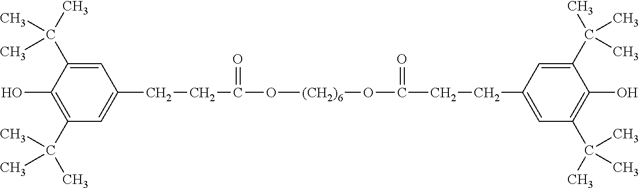

(Irganox® 259 from Ciba-Geigy)

All of the following should be mentioned as examples of sterically hindered phenols:
2,2′-methylenebis(4-methyl-6-tert-butylphenol), 1,6-hexanediol bis[3-(3,5-di-tert-butyl-4-hydroxyphenyl)propionate], pentaerythritol tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from Ciba Geigy, which has particularly good suitability.

The amount comprised of the antioxidants C2), which can be used individually or as a mixture, is from 0.05 up to 3% by weight, preferably from 0.1 to 1.5% by weight, in particular from 0.1 to 1% by weight, based on the total weight of the molding compositions A) to C).

In some instances, sterically hindered phenols having not more than one sterically hindered group in ortho-position with respect to the phenolic hydroxy group have proven particularly advantageous; in particular when assessing colorfastness on storage in diffuse light over prolonged periods.

The molding compositions of the invention can comprise, as component C2), from 0.05 to 5% by weight, preferably from 0.1 to 2% by weight, and in particular from 0.25 to 1% by weight, of a nigrosine.

Nigrosines are generally a group of black or gray phenazine dyes (azine dyes) related to the indulines and taking various forms (water-soluble, oleosoluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosines are obtained industrially via heating of nitrobenzene, aniline, and aniline hydrochloride with metallic iron and FeCl₃ (the name being derived from the Latin niger=black).

Component C2) can be used in the form of free base or else in the form of salt (e.g. hydrochloride).

Further details concerning nigrosines can be found by way of example in the electronic encyclopedia Römpp Online, Version 2.8, Thieme-Verlag Stuttgart, 2006, keyword “Nigrosine”.

Examples of other conventional additives C2) are amounts of up to 25% by weight, preferably up to 20% by weight, of elastomeric polymers (also often termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These dicarboxylic acid derivatives or monomers comprising epoxy groups are preferably incorporated into the rubber by adding to the monomer mixture monomers comprising dicarboxylic acid groups and/or epoxy groups and having the general formulae I or II or III or IV

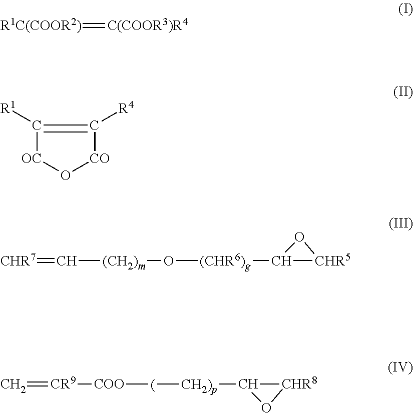

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as, for example, n-butyl acrylate and 2-ethylhexyl acrylate, corresponding methacrylates, butadiene and isoprene, and also mixtures of these. These monomers may be copolymerized with other monomers, such as, for example, styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

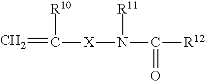

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise 0 or by groups that comprise N,
X is a chemical bond, a C₁-C₁₀-alkylene group, or a C₆-C₁₂-arylene group, or

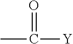

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl |
| | acrylate, ethylhexyl acrylate, | methacrylate |
| | or a mixture of these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, methyl | first envelope composed of |
| | methacrylate, or a mixture | monomers as described under I |
| | of these | and II for the core, second |
| | | envelope as described under |
| | | I or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate/(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

The thermoplastic molding compositions of the invention can comprise, as component C2), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, flame retardants, etc.

Examples of oxidation retarders and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 1% by weight, based on the weight of the thermoplastic molding compositions.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc.

The thermoplastic molding compositions of the invention can be produced by processes known per se, by mixing the starting components in conventional mixing apparatus, such as screw-based extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The mixing temperatures are generally from 230 to 320° C.

In another preferred mode of operation, components B) and also optionally C) can be mixed with a prepolymer, compounded, and pelletized. The pellets obtained are then solid-phase condensed under an inert gas continuously or batchwise at a temperature below the melting point of component A) until the desired viscosity has been reached.

The thermoplastic molding compositions of the invention feature good processability together with good mechanical properties, and also markedly improved weld line strength, and also thermal stability.

These materials are suitable for the production of fibers, foils, and moldings of any type. Some examples follow: cylinder head covers, motorcycle covers, intake pipes, charge-air-cooler caps, plug connectors, gearwheels, cooling-fan wheels, and cooling-water tanks.

In the electrical and electronic sector, improved-flow polyamides can be used to produce plugs, plug parts, plug connectors, membrane switches, printed circuit board modules, microelectronic components, coils, I/O plug connectors, plugs for printed circuit boards (PCBs), plugs for flexible printed circuits (FPCs), plugs for flexible integrated circuits (FFCs), high-speed plug connections, terminal strips, connector plugs, device connectors, cable-harness components, circuit mounts, circuit-mount components, three-dimensionally injection-molded circuit mounts, electrical connection elements, and mechatronic components.

Possible uses in automobile interiors are for dashboards, steering-column switches, seat components, headrests, center consoles, gearbox components, and door modules, and possible uses in automobile exteriors are for door handles, exterior-mirror components, windshield-wiper components, windshield-wiper protective housings, grilles, roof rails, sunroof frames, engine covers, cylinder head covers, intake pipes (in particular intake manifolds), windshield wipers, and also external bodywork components.

Possible uses of improved-flow polyamides in the kitchen and household sector are for the production of components for kitchen devices, e.g. fryers, smoothing irons, knobs, and also applications in the garden and leisure sector, e.g. components for irrigation systems, or garden devices, and door handles.

### EXAMPLES

The following components were used:

### Component A/1

Nylon-66 with intrinsic viscosity IV of 148 ml/g, measured on a 0.5% strength by weight solution in 96% strength by weight sulfuric acid at 25° C. to ISO 307. (Ultramid® A27 from BASF SE was used.)

### Production of Component B/1: Polyacrylamide

611.5 g of demineralized water and 8.5 g of 1% strength Trilon C solution (diethylenetriaminepentaacetic acid) were used as initial charge in a 2 l glass reactor with anchor stirrer, reflux condenser, internal thermometer, and gas inlet tube. Said initial charge was heated to 80° C. by a heating bath and freed from oxygen by introducing nitrogen for 30 minutes. Nitrogen was also continuously passed through the apparatus during the polymerization reaction. 480 g of a 50% strength aqueous acrylamide solution and, in parallel with this, 105 g of a 2% strength aqueous solution of 2,2′-azobis(2-methylpropionamidine) dihydrochloride, were fed into the mixture within a period of 1.5 h, with the rotation rate set at 100 rpm. Once the two feeds had ended, polymerization was continued for a further 3 h at 80° C., and then the product was cooled to room temperature. This gave a clear, almost colorless, viscose solution of polyacrylamide:

| | |
|---|---|
| Solids content | 20.3% |
| Viscosity | 640 mPas (Brookfield, spindle 3, 50 rpm) |
| K value | 57 (1% concentration in water) |

### B2a: Polyvinylformamide (Lupamin® 4500)

1110.0 g of demineralized water and 4.1 g of 75% strength phosphoric acid were mixed in a 2 l glass apparatus with anchor stirrer, condenser, internal thermometer, and nitrogen inlet tube, with the rotation rate set at 100 rpm. The pH was adjusted to 6.5 via dropwise addition of 5.8 g of a 25% strength aqueous sodium hydroxide solution. The mixture was heated to 80° C., with introduction of nitrogen. Nitrogen was introduced for a total of 30 minutes. Once the temperature had been reached, vacuum (about 450 mbar) was applied to the apparatus, in such a way as just to cause onset of boiling of the initial charge. 436.5 g of N-vinylformamide and, in parallel with this, 7.8 g of 2,2′-azobis(2-methylpropionamidine) dihydrochloride, dissolved in 88 g of demineralized water, were then fed into the mixture within a period of 3 h. Once the feeds had ended, polymerization was continued at 80° C. for a further 2 hours. The total amount of water removed by distillation during the polymerization reaction and the continued polymerization reaction was 450 g. The vacuum was then broken, and the mixture was cooled to room temperature. This gave a clear, slightly yellow viscose solution of polyvinylformamide.

| | |
|---|---|
| Solids content | 36.2% |
| Viscosity | 4400 mPas (Brookfield, spindle 3, 20 rpm) |
| K value | 46 (1% concentration in water) |
| Mw | 45 000 daltons |

### B2b: Polyvinylformamide (Lupamin® 9000)

1102.0 g of demineralized water and 2.6 g of 75% strength phosphoric acid were mixed in a 2 l glass reactor with anchor stirrer, condenser, internal thermometer, and nitrogen inlet tube, with the rotation rate set at 100 rpm. The pH was adjusted to 6.5 via dropwise addition of 3.8 g of a 25% strength aqueous sodium hydroxide solution. The mixture was heated to 77° C., with introduction of nitrogen. Nitrogen was introduced for a total of 30 minutes. Once the temperature had been reached, vacuum (about 410 mbar) was applied to the apparatus, in such a way as just to cause onset of boiling of the initial charge. 234.0 g of N-vinylformamide were then fed into the mixture within a period of 90 min. Simultaneously with the VFA, the initiator feed was started. It includes 1.1 g of 2,2″-azobis(2-methylpropionamidine) dihydro-chloride dissolved in 58 g of demineralized water, and was fed into the mixture within a period of 2 hours 50 min. Once the initiator feed had ended, polymerization was continued at 77° C. for a further 3 hours. The total amount of water removed by distillation during the polymerization reaction and the continued polymerization reaction was 232 g. The vacuum was then broken, and the mixture was diluted with 632 g of demineralized water and cooled to room temperature. This gave a clear, slightly yellow viscose solution of polyvinylformamide.

| | |
|---|---|
| Solids content | 13.1% |
| Viscosity | 2500 mPas (Brookfield, spindle 3, 20 rpm) |
| K value | 89 (1% concentration in water) |
| Mw | 340 000 daltons |

### Characterization Methods for Components B:

Solids contents were determined gravimetrically. Drying took place in a convection drying oven, for 2 hours at 140° C.

Viscosities were measured with a Brookfield viscometer under the conditions stated in brackets.

The molecular weights M_{w} of the polymers were determined with the aid of static light scattering. The measurements were carried out at pH 7.6 in 10 mmolar aqueous sodium chloride solution.

The K values were determined by the method of H. Fikentscher, Cellulosechemie, volume 13, 48-64 and 71-74 (1932), at 25° C. and at a pH of 7, under the conditions stated in brackets.

### Component C/1

Glass fibers

### Component C/2a

Ca stearate

### Component C/2b

CuI/KI in ratio 1:4 (20% strength masterbatch in PA6)
Component C/2c 40% masterbatch of Nigrosine in PA6

The molding compositions were produced in a ZSK 30 with 25 kg/h throughput, with a flat temperature profile at about 280° C.

The following tests were carried out:

Tensile test to ISO 527, mechanical properties prior to and after heat-aging at 200° C. and, respectively, 220° C. in a convection oven

IV: c=5 g/l in 96% strength sulfuric acid, to ISO 307

The tables give the constitutions of the molding compositions and the results of the tests.

TABLE 1
Constitutions

| | A | C/1 | C/2a | C/2b | C/2c | B1 | B2a | B2b |
|---|---|---|---|---|---|---|---|---|
| Ex. | (%) | (%) | (%) | (%) | (%) | (%) | (%) | (%) |
| 1 Comp. | 67.45 | 30 | 0.35 | 0.3 | 1.9 | | | |
| 1 | 66.95 | 30 | 0.35 | 0.3 | 1.9 | 0.5 | | |
| 2 | 66.45 | 30 | 0.35 | 0.3 | 1.9 | 1.0 | | |
| 3 | 66.95 | 30 | 0.35 | 0.3 | 1.9 | | 0.5 | |
| 4 | 66.45 | 30 | 0.35 | 0.3 | 1.9 | | 1.0 | |
| 5 | 66.95 | 30 | 0.35 | 0.3 | 1.9 | | | 0.5 |
| 6 | 66.45 | 30 | 0.35 | 0.3 | 1.9 | | | 1.0 |

TABLE 2
Mechanical properties after heat-aging at 220° C.

| | | | | |
|---|---|---|---|---|
| Ex. | 0 h | 250 h | 500 h | 750 h |

Modulus of elasticity [MPa]

| | | | | |
|---|---|---|---|---|
| 1Comp. | 9830 | 10 580 | 10 200 | 8400 |
| 1 | 9430 | 10 420 | 10 570 | 10 220 |
| 2 | 9440 | 10 330 | 10 400 | 10 110 |
| 3 | 9380 | 10 260 | 10 220 | 10 160 |
| 4 | 9300 | 10 390 | 10 590 | 10 200 |
| 5 | 9420 | 10 240 | 10 370 | 10 200 |
| 6 | 9260 | 10 240 | 10 310 | |

Tensile strength [MPa]
(Tensile stress at break)

| | | | | |
|---|---|---|---|---|
| 1Comp. | 187 | 158 | 121 | 71 |
| 1 | 183 | 165 | 147 | 118 |
| 2 | 183 | 175 | 171 | 118 |
| 3 | 183 | 168 | 150 | 124 |
| 4 | 181 | 177 | 173 | 132 |
| 5 | 184 | 168 | 152 | 120 |
| 6 | 180 | 177 | 156 | |

Elongation at break [%]
(Tensile stress at break)

| | | | | |
|---|---|---|---|---|
| 1Comp. | 3.4 | 1.8 | 1.3 | 1.0 |
| 1 | 3.4 | 2.0 | 1.7 | 1.3 |
| 2 | 3.4 | 2.3 | 2.4 | 1.3 |
| 3 | 3.4 | 2.1 | 1.8 | 1.4 |
| 4 | 3.4 | 2.3 | 2.3 | 1.5 |
| 5 | 3.5 | 2.1 | 1.8 | 1.3 |
| 6 | 3.5 | 2.4 | 2.0 | |

TABLE 3
Mechanical properties after heat-aging at 200° C.

| Ex. | 0 h | 250 h | 500 h | 750 h | 1000 h |
|---|---|---|---|---|---|
| | Tensile strength [MPa] | | | | |
| | (Tensile stress at break) | | | | |
| 1Comp. | 187 | 172 | 146 | 141 | 129 |
| 2 | 183 | 154 | 144 | 145 | 136 |
| 4 | 181 | 158 | 149 | 152 | 145 |
| 6 | 180 | 158 | 149 | 154 | 145 |
| | Elongation at break [%] | | | | |
| | (Tensile strain at break) | | | | |
| 1Comp. | 3.4 | 2.0 | 1.6 | 1.6 | 1.4 |
| 2 | 3.4 | 1.9 | 1.7 | 1.7 | 1.6 |
| 4 | 3.4 | 2.0 | 1.8 | 1.8 | 1.7 |
| 6 | 3.5 | 2.0 | 1.8 | 1.9 | 1.8 |

1-9. (canceled)

10. A thermoplastic molding composition comprising
D) from 10 to 99% by weight of a polyamide,
E) from 0.1 to 20% by weight of
B1) a polyacrylamide or
B2) a polyvinylamide, or a mixture of these,
F) from 0 to 70% by weight of further additives,
where the total of the percentages by weight of components A) to C) does not exceed 100%.

11. The thermoplastic molding composition according to claim 10, in which B1) is obtainable via free-radical polymerization of monomers of the formula I 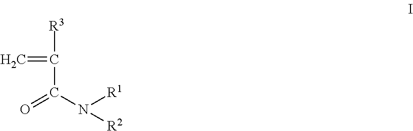
in which R¹ and R², independently of one another, are hydrogen or C₁-C₆-alkyl, and R³ is hydrogen or methyl.

12. The thermoplastic molding composition according to claim 10, in which R¹ and R² in formula I of component B1) are hydrogen.

13. The thermoplastic molding composition according to claim 10, in which B2) is obtainable via polymerization of monomers of the formula II 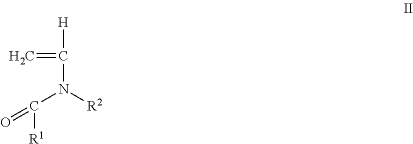
in which R¹ and R², independently of one another, are hydrogen or C₁-C₆-alkyl.

14. The thermoplastic molding composition according to claim 10, in which the K value of B1) is from 10 to 200 and/or the K value of B2 is from 15 to 250.

15. The thermoplastic molding composition according to claim 10, in which the average molecular weight M_{w} of B1) is from 5000 to 5 000 000, and/or the average molecular weight M_{w} of B2) is from 15 000 to 10 million.

16. The thermoplastic molding composition according to claim 10, comprising
G) from 20 to 98% by weight
H) from 0.1 to 10% by weight
C1) 1 to 40% by weight of a fibrous or particulate filler or a mixture of these
C2) from 0 to 50% by weight of further additives,
where the total of the percentages by weight of A) to C) does not exceed 100%.

17. A process for producing fibers, foils or moldings of any type which comprises utilizing the thermoplastic molding composition according to claim 10.

18. A fiber, foil, or molding of any type obtainable from the thermoplastic molding compositions according to claim 10.
